(19) United States
(12) Patent Application Publication
(10) Pub. No.: US 2002/0071788 A1
(43) Pub. Date: Jun. 13, 2002

(54) Microchip

(75) Inventors: Yasuhisa Fujii, Kyoto-Shi (JP); Yasuhiro Sando, Amagasaki-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/008,398

(22) Filed: Dec. 6, 2001

(30) Foreign Application Priority Data
Dec. 8, 2000 (JP) 2000-374860
Oct. 1, 2001 (JP) 2001-305234

(51) Int. Cl. B01J 19/00

(52) U.S. Cl. 422/102; 422/99; 422/130; 422/131; 436/174; 436/180

(57) ABSTRACT

A microchip comprises a plurality of supply units capable of supplying a plurality of fluids, a common unit commonly provided for the plurality of supply units, and a flow pass connecting each supply unit and the common unit. The flow pass allows each fluid supplied by each supply unit to flow to the common unit. The dimensions and shape of the flow pass determines the relative timing for each fluid supplied from each supply unit to reach the common unit.

### RELATED APPLICATIONS

This application is based on Japanese Patent Application Nos. 2000-374860 and 2001-0305234 filed in Japan on Dec. 8, 2000 and Oct. 1, 2001, respectively, the entire contents of which are hereby incorporated by reference.

### FIELD OF THE INVENTION

The present invention relates to a microchip. One embodiment of the present invention specifically relates to a microchip for use in examinations as applied to micro fluid systems.

### BACKGROUND OF THE INVENTION

Conventionally, large-scale devices with installed robots have been used in clinical examinations. For example, blood plasma is separated, and the plasma is dispensed in a fixed quantity to a cuvette using a dispenser, diluted, and thereafter reagent is injected, mixed, and rinsed, in a continuous repeated operation (2 to 5 times). Detection is then performed (mainly photo detection).

In this type of large-scale device, normally, approximately 10 milliliters of blood are collected from a patient. The blood is centrifuged using a centrifuge to separate the plasma, which is then collected. There is a large amount of blood used, and the examination takes much time.

The robot uses a single cuvette, and uses a large arm to move a dispenser to a plurality of different reagent vessels and washing agent vessels for collecting reagents and washing agents, respectively. The robot moves the dispenser to the cuvette and injects the materials therein, agitates the cuvette to induce a reaction, then cleans the cuvette. This operation can be continuously repeated as desired, for example, using various reagents. For this reason, the examination takes a long time. Energy consumption is also great.

Furthermore, the device is expensive, costing for example, several hundreds of thousands of dollars in the case of a large-scale device. Even a relatively small device having less processing power can cost several tens of thousands of dollars or more.

The costs of reagent and waste processing are also high.

In recent years, the fields of chemical technology and biotechnology have seen enthusiastic research and development of compact micro fluid systems for chemical analysis systems using micro machine technology and MEMS (micro-electro-mechanical systems) technology, particularly in Europe and the United States.

In the background, there are growing needs for high-speed and high-precision handling of micro fluids in the fields of biotechnology, as represented by DNA analysis, and chemical technology, as represented by new drug development, wherein target drugs are sought among combinations of large quantities of reagents.

Many effects are obtained in micro fluid systems. Since the reaction surface area per unit volume is large, miniaturization can provide many advantages. For example, reaction time can be greatly reduced, high throughput can be realized, precise flow control is possible, it is easy to maintain a uniform temperature of the fluid due to the small amount of fluid, precise temperature control is possible because of the small heat capacity, reactions which are potentially volatile can be safely conducted, and the amount of reagent used as well as the amount of waste product produced are greatly reduced.

In this way, it is believed that micro fluid systems will have a very great influence in many industries, such as the chemical industry, the pharmaceutical industry, the biotechnology and related industries, the food-related industries, the agricultural technology industry, and the like.

The mainstream of research and development of micro fluid systems, in looking toward special uses, is a monolithic type wherein the system structural devices, such as a micro flow pass, micro reactor, micro pump and the like, are formed on a single chip of silicon substrate, glass substrate or the like, and mixing, reaction, separation, and detection are continuously performed therein. These micro fluid systems can be broadly divided into types using mechanical fluid control mechanisms including system structural devices such as micro pumps, micro valves and the like, for which research is advanced mainly in Europe; and capillary migration types, which use an electroendosmosis phenomenon, for which research is advanced mainly in the United States.

For example, the concept of a healthcare device in which a micro plasma power source, capillary, micro pump, filter, micro spectroscope, integrated circuit, and detection circuit formed on a silicon substrate are packaged in a single chip has been advanced in Nikkei Microdevice, July, 2000, pp. 88-97.

This article, however, does not propose a specific structure of such a device.

### SUMMARY OF THE INVENTION

Therefore, an object of the present invention is to provide a specific structure of a microchip used for examinations applied to micro fluid systems.

The present invention eliminates the problems of the art by providing a microchip having the structure described below.

In one embodiment, a microchip comprises a plurality of supply units capable of supplying a plurality of fluids, a common unit (reaction chamber) commonly provided for the plurality of supply units, and a flow pass connecting each supply unit and the common unit. The flow pass allows each fluid supplied by each supply unit to flow to the common unit. The dimensions and shape of the flow pass is designed to determine the relative timing relationship for each fluid supplied from each supply unit to reach the common unit.

According to this structure, since the dimensions and the shape of the flow pass is designed to determine the relative timing relationship for each fluid supplied from each supply unit to reach the common unit, each fluid supplied from each supply unit flows into the common unit with a specific timing.

According to this structure, for example, specimen, reagent, washing agent, and the like flow from the supply units to the common unit with a specific timing. A chemical or physical reaction is generated, this reaction is detected, and the reactant is extracted. In one embodiment, a plasma separation mechanism, such as a filter, cartridge, pump, immobilized enzyme, sensing mechanism, or the like, may be provided at a suitable position in the flow pass or the common unit as necessary.

According to this structure, the majority of the mechanism required to generate a reaction can be provided in the microchip. The dimensions and the shape of the flow pass are employed as a structural element for determining a time element, and is controllable.

Accordingly, it is possible to use a small amount of specimen, generate a reaction in a short time, render the examination device in a compact form-factor, and lower the cost of the examination.

In one embodiment, it is desirable that a suction unit is provided to simultaneously suction each fluid supplied from each supply unit toward the common unit.

In this embodiment, the suction unit may be provided with, for example, a micro pump for transporting fluid within the common unit or back and forth between the supply unit and the common unit. A suction port, which is connected to the common unit, may be provided for suctioning fluid from the microchip.

In one embodiment, the time required for each fluid to reach the common unit and the quantity of each fluid can be controlled, when each fluid supplied from each supply unit is suctioned simultaneously to the common unit, by suitably selecting the dimension and shape of the flow pass cross section, such as the length, curvature, and confluence position of the flow pass, from each supply unit to the common unit. That is, the timing with which each fluid reaches the common unit can be determined solely by the structure of the microchip itself

It is desirable that the flow pass includes a plurality of branch flow passes respectively connected to each supply unit.

In one embodiment, the branch flow passes allow specimen, reagent, washing agent and the like to flow from a supply unit for numerous reactions and washings. In another embodiment, the quantity of each fluid and the timing with which each fluid reaches the common unit can be controlled with greater precision by disposing a micro pump, operating valve or the like in the branch flow pass.

Further, the present invention provides a microchip having the structure described below.

In one embodiment, a microchip comprises a plurality of supply units, sequentially provided on a common flow pass, and capable of supplying a plurality of fluids. The microchip further comprises a common unit commonly provided for the plurality of supply units. An arrangement order of the supply units on the common flow pass determines a temporal order of the relative timing relationship for each fluid supplied from each supply unit to reach the common unit.

According to this structure, a temporal order of the relative timing relationship for each fluid supplied from each supply unit to reach the common unit can be determined by suitably designating the sequence or order in which each supply unit is arranged with respect to other supply units and the common unit. Since the flow pass is not branched, the structure is simple. Further, the relative timing relationship for each fluid supplied from each supply unit to reach the common unit can be determined by suitably designating the dimensions and shape of the flow pass between each supply unit.

According to this structure, for instance, specimen, reagent and washing agent can be supplied to the common unit with a prescribed sequence and timing, and thereby chemical or physical reactions can be caused, and the reactions/reactants can be observed/abstracted. A Plasma separation mechanism such as a filter, a cartridge, a pump, an immobilized enzyme, and/or a sensing mechanism may be provided at appropriate portions of the flow pass and common unit.

According to the above mentioned structure, the majority of elements necessary for the reactions can be provided on the microchip. This microchip employs the arrangement order of the supply units for determining the temporal order of the relative timing relationship. Therefore, by this microchip, using only fine amount of specimen, causing the reactions in short term, reducing the size of the examination equipment, and reducing cost of the examination can be achieved.

Further, the present invention provides a microchip having the structure described below.

In one embodiment, a microchip comprises a plurality of supply units capable of supplying a plurality of fluids, a common unit commonly provided for the plurality of supply units, a plurality of flow passes connecting the supply units with the common unit, respectively, and a plurality of flow controllers provided in the flow passes for controlling flows of the fluids supplied in the supply units, respectively.

According to the above mentioned structure, the flow timing of the fluids supplied to the supply units can be accurately determined by controlling flows of the fluids supplied in the supply units by the plurality of flow controllers. Further, according to this structure, for instance, specimen, reagent and washing agent can be supplied to the common unit with a prescribed sequence and timing, and thereby chemical or physical reactions can be caused, and the reactions/reactants can be observed/abstracted. Plasma separation mechanism such as filter, cartridge, pump, immobilized enzyme, and sensing mechanism may be provided at appropriate portions of the flow pass and common unit.

As to the each of the flow controllers, a micro valve or a micro pump can be employed.

In any one of the above described embodiments of the microchips, it is desirable that the common unit includes a sensor unit for adhering specimen, and a discharge unit for discharging fluid from the sensor unit.

In any one of the above described embodiments of the microchips, specimen, reagent, washing agent and the like flow from a supply unit to a common unit with a specific timing, the specimen is captured by the sensor unit, a chemical or physical reaction is generated relative to the specimen in the sensor unit, and this reaction is detected. Excess reagent is eliminated from the sensor unit by the discharge unit, and the sensor unit is washed by the washing agent. Accordingly, the microchip may be widely used with various methods of examination.

### BRIEF DESCRIPTION OF THE DRAWINGS

A more complete understanding of the present invention and its advantages will be readily apparent from the following Detailed Description of the Preferred Embodiments taken in conjunction with the accompanying drawings. Throughout the accompanying drawings, like parts are designated by like reference numbers, and in which:

FIG. 1 is a structural view of a microchip according to one embodiment of the present invention;

FIG. 2 is a structural view of a microchip of a second embodiment of the present invention;

FIG. 3 is a structural view of a microchip of a third embodiment of the present invention;

FIG. 4 is a structural view of a microchip of a fourth embodiment of the present invention;

FIG. 5 is a structural view of a microchip of a fifth embodiment of the present invention;

FIG. 6 is a structural view of a microchip of a sixth embodiment of the present invention;

FIG. 7 is a structural view of a microchip of a seventh embodiment of the present invention;

FIG. 8 is a structural view of a microchip of an eighth embodiment of the present invention;

FIGS. 9(a) and 9(b) shows a cross sectional view and a plan structural view of a microchip of the present invention; and

FIG. 10 is a basic structural view of another embodiment of the present invention.

### DETAILED DESCRIPTION OF THE PREFERRED EMBODIMENTS

The embodiments of the microchip of the present invention are described hereinafter with reference to the accompanying drawings.

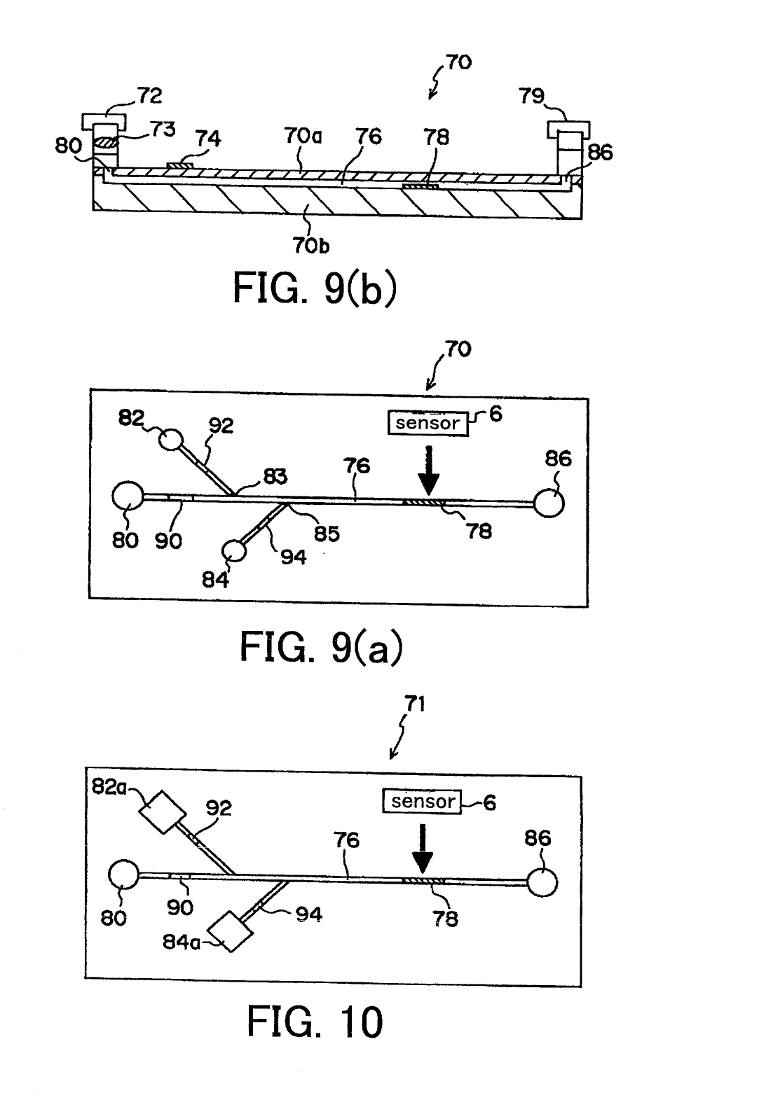

First, the basic structure of the microchip is described with reference to FIGS. 9(a) and 9(b).

As shown in the cross sectional view of FIG. 9(a), a microchip 70 comprises a cover 70a, and substrate 70b on which is formed a fine flow pass 76. The specimen flows from a fluid inlet 72 through a separation filter 73 to the flow pass 76. A reaction component is adsorbed by a specimen fixing unit 78, and the remaining liquid is discharged from a liquid discharge outlet 79. A diffuser type micro pump is disposed at a suitable location in the flow pass 76 for transporting liquid by, for example, unimorph drive of the cover 70a being oscillated by a PZT [Pb(Zr, Ti)O₃] 74.

As shown in the plan structural view of FIG. 9(b), the flow pass 76 is branched. A terminus of each branch is respectively provided with a specimen inlet 80 for supplying specimen, two reagent inlets 82 and 84 for supplying reagent, and a liquid discharge outlet 86 for discharging liquid. A specimen fixing unit 78 is provided on the liquid discharge outlet 86 side (trunk side) of the flow pass 76, such that a reaction can be detected proximate the specimen fixing unit 78 by the sensor 6 of an examination device (not shown) in which the microchip 70 is installed. Micro pumps 90, 92 and 94 are respectively provided at the specimen inlet 80, and the reagent inlets 82 and 84 sides (branch areas) of the flow pass 76 to allow specimen and reagent to flow toward the liquid discharge outlet 86 with a specific timing. Valves 83 and 85 are provided at the confluence area of the flow pass 76 on the reagent inlet 82 and 84 side, and at the flow pass 76 on the specimen inlet 80 side.

The microchip 70 can perform examinations in the same sequence as in the conventional immunological measurements. As to the conventional immunological measurements, for instance, ELSIA F-HBs antigen-antibody reaction sequence, that are achieved by using a large-scale ELSIA F750 (available from International Reagents Corporation, Japan), examination and measurement such as coagulative fibrinolysis marker, hormone, infection, tumor marker and the like can be performed.

That is, first, specimen (blood plasma) is injected into the fluid inlet 72 of the microchip 70, and the blood plasma is separated by the separation filter 73. The separated plasma is transported by the micro pump 90 to the specimen fixing unit 78 which contained fixed HBs antibody. The specimen reacts with the HBs antibody by a characteristic spontaneous diffusion in the flow pass 76. Then, a washing agent is injected from the fluid inlet 72, the liquid is transported by the micro pump 90, and the interior of the flow pass 76 is washed.

Next, the valve 83 is opened, and POD (peroxidase) HBs antibody (marker antibody) is fed from the reagent inlet 82 through the branch flow pass to the main flow pass by the micro pump 92, and is transported to the specimen fixing unit 78. Then, the complex of the fixed HBs antibody and specimen is reacted with the marker antibody. Washing agent is then injected from the reagent inlet 82, and the washing agent is transported by the micro pump 92 and washes the interior of the flow pass 76.

Next, the valve 85 is opened, and HPPA (p-hydroxyphenylpropionic acid) substrate is directed from the branch flow pass to the main flow pass 76 by the micro pump 94. Then, washing agent is injected from the reagent inlet 84, and the washing agent is fed by the micro pump 94 to wash the interior of the flow pass 76.

Finally, light from the HBs antibody complex part fixed by the specimen fixing unit 78 is detected by the sensor unit 6, and quantitatively analyzed. Specifically the marker is excited by laser light emitted from a light source, and the generated fluorescence is detected by a photodetector.

This continuous sequence is not limited to ELSIA, and the flow passes of the microchip, blood plasma separation mechanism, pumps, valves, immobilized enzyme, and sensing mechanism may be disposed at specific positions in accordance with an examination sequence, and operated in accordance with fluid movement for all immunological measurements and biochemical measurements.

Furthermore, reagent need not be supplied by valve, but also may be supplied by cartridges 82a and 84a as shown in the embodiment of the microchip of FIG. 10.

In addition, the washing agent may flow from a special flow pass.

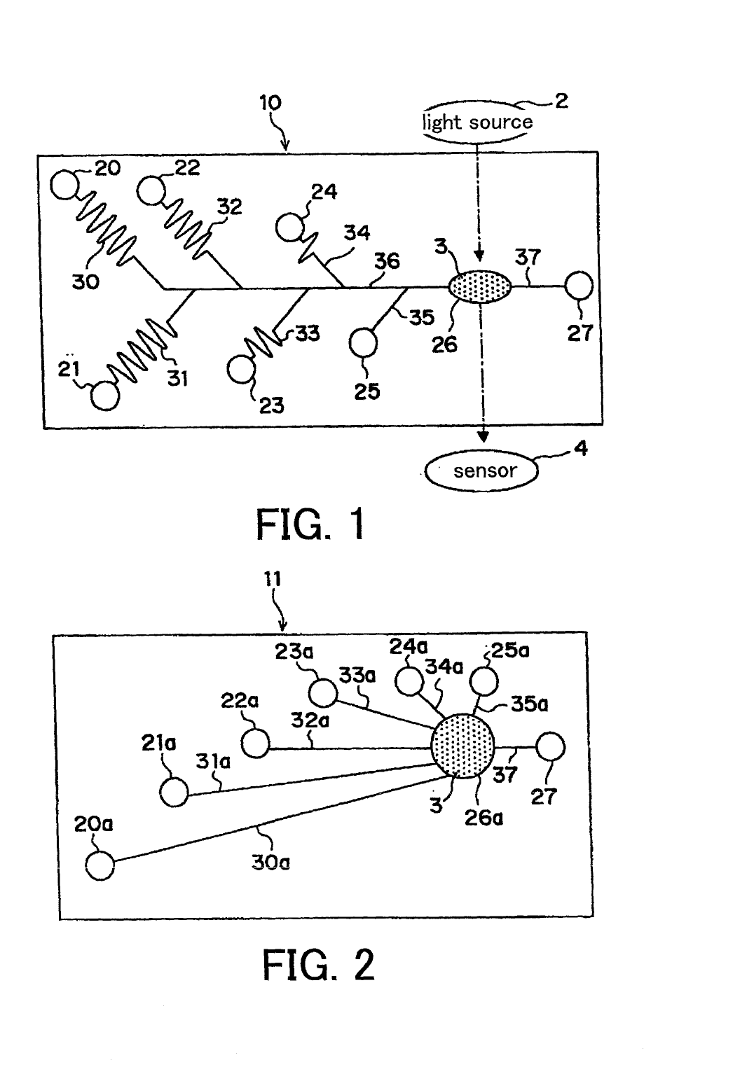

The specific structure of the microchip is described below with reference to FIGS. 1 through 8. In the drawings, like parts are designated by like reference numbers.

FIG. 1 is a structural view of an embodiment of a microchip 10 used for immunological examination. In the drawing, reference number 20-25 refer to fluid chambers. Chambers 20, 22, and 24 supply washing agent, chamber 21 supplies BPPA substrate, chamber 23 supplies marker antibody, and chamber 25 supplies specimen. The materials are supplied from holes through each fluid chamber 20-25. Reference number 26 refers to a chamber for supplying reagent which is fixed in the flow pass (reaction chamber), and specimen and reagent are reacted in this chamber. HBs antibody is fixed in the reaction chamber 26, and the reaction component (antigen) in the specimen is adhered. Reference number 27 refers to a suction port for drawing each fluid. Fine flow passes 30-37 connect the fluid chambers 20-25, reaction chamber 26, and suction port 27.

When suctioned by a micro-syringe or the like from the suction port 27, each fluid supplied from fluid chambers 20-25 flows through the flow passes 30-36, and, near the reaction chamber 26, sequentially reaches the reaction chamber 26 and are reacted in order according to the examination sequence. Excess specimen, reagent, and washing agent after washing are suctioned from the flow pass 37 and discharged from the suction port 27.

That is, first, specimen from the fluid chamber 25 passes through the reaction chamber 26, and the antigen in the specimen bonds with the HBs antibody 3 fixed to the reaction chamber 26.

Then, washing agent from the fluid chamber 24 flows through the reaction chamber 26 and washes the chamber, and only the complex of bonded HBs antibody 3 and antigen remain in the reaction chamber 26.

Next, marker antibody from the fluid chamber 23 passes through the reaction chamber 26, and the complex of HBs antibody 3 and antigen bonds to the marker antibody.

Then, washing agent from the fluid chamber 22 flows through the reaction chamber 26 and washes the chamber, and only the complex of bonded marker antibody, HBs antibody 3 and antigen remain in the reaction chamber 26.

Next, HPPA substrate from the fluid chamber 21 passes through the reaction chamber 26, and produces fluorescent material in the complex of bonded marker antibody, HBs antibody 3 and antigen.

Finally, washing agent from the fluid chamber 20 flows through the reaction chamber 26, and washes the chamber. The fluorescent material produced by the reaction with HPPA substrate remains. This fluorescent material is irradiated with light of a specific wavelength (e.g., 495 nm) from a light source in the examination device (not shown), and the generated fluorescence (e.g., 515 nm) is detected by a photosensor 4 of the examination device (not shown).

The microchip 10 controls the timing of the sequence by adjusting the distances of the flow passes 30-36 from each fluid chamber 20-25 to the reaction chamber 26.

The flow passes 30-36 shown in FIG. 1 are not limited to a single flow pass with branches, inasmuch as the fluid from the fluid chambers 20a-25a also may be supplied to a reaction chamber 26a through individual flow passes 30a-35a as in an embodiment of a microchip 11 of FIG. 2. In this case, the control of the timing of the flow to the reaction chamber 26a is determined by the length of the flow passes 30a-35a.

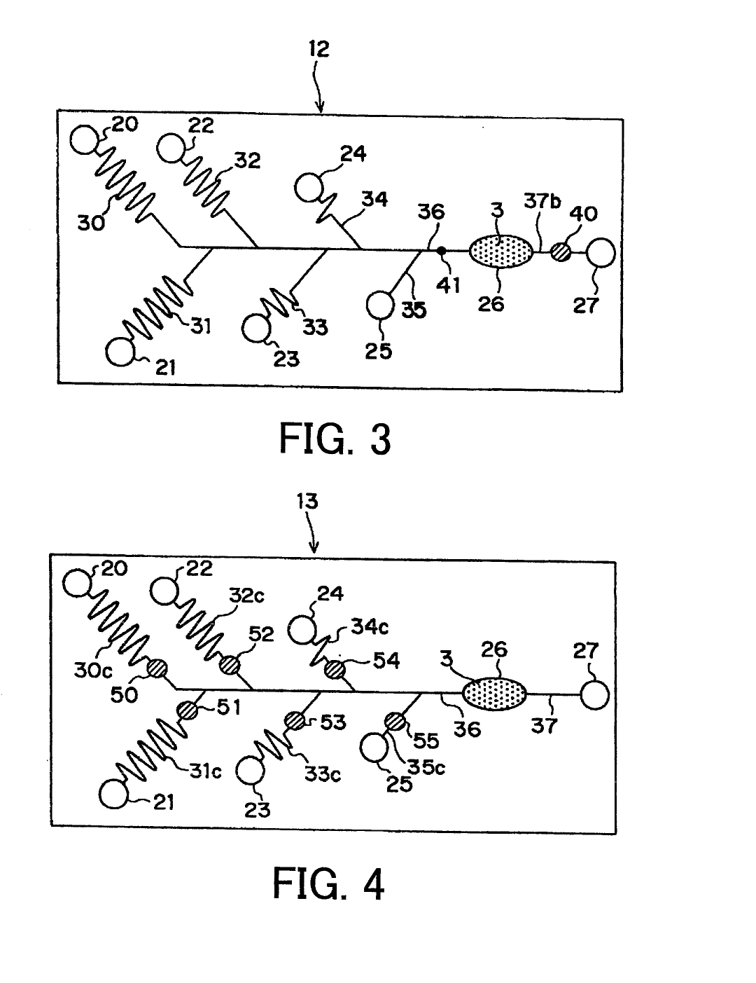

A micro pump 40 may be disposed within a flow pass 37b to transport fluid, as shown in an embodiment of a microchip 12 of FIG. 3. The micro pump 40 need not be disposed within the flow pass 37b , and may be a position 41 in front of the reaction chamber 26.

Each fluid may be transported individually by pumps 50-55 respectively disposed in the flow passes 30c-35c as in an embodiment of a microchip 13 of FIG. 4. More precise transport timing can be accommodated by controlling the drive timing of the pumps 50-55.

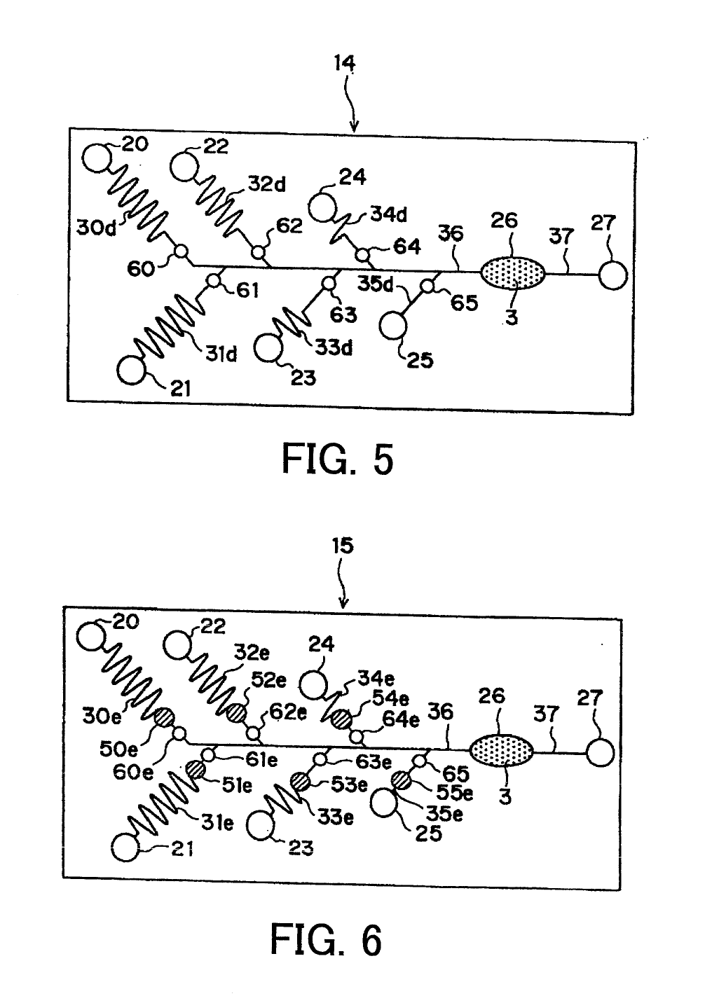

Valves 60-65 also may be disposed before the confluence of the flow passes 30d-35d with the main flow pass 36 as in an embodiment of a microchip 14 of FIG. 5. More precise transport timing can be accommodated by turning ON/OFF the flow of each fluid via the valves 60-65.

Even more accurate flow can be attained by combining valves 60e-65e and pumps 50e-55e provided in flow passes 30e-35e as in an embodiment of a microchip 15 of FIG. 6.

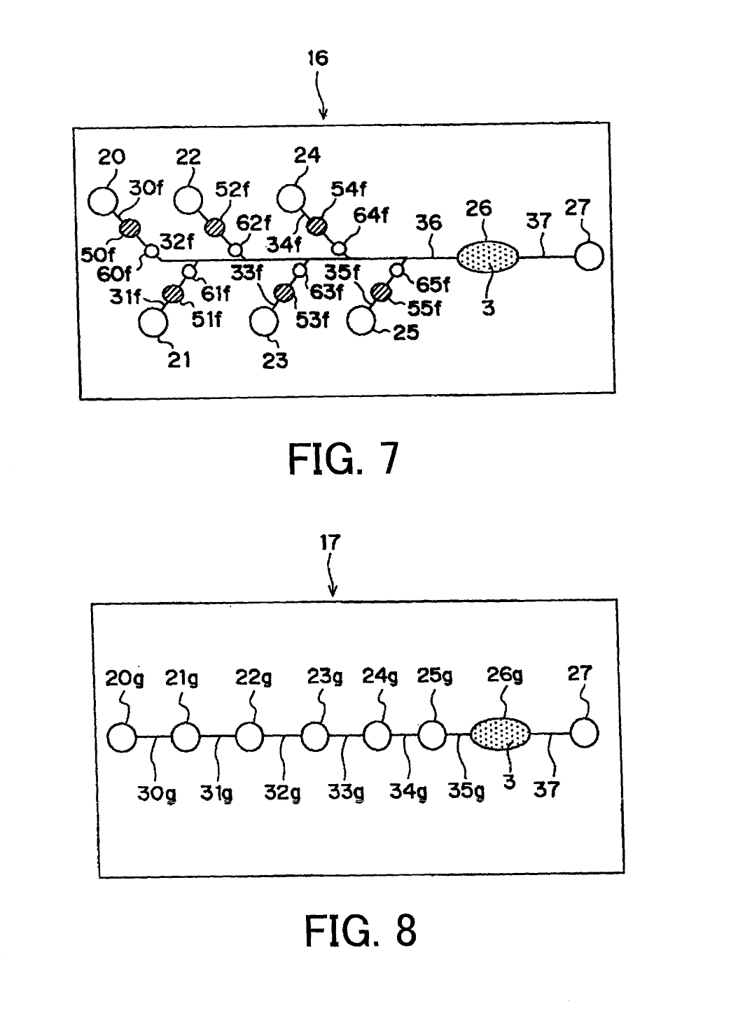

When a pump and valve are disposed in each branch as shown in FIGS. 4-6, it is unnecessary to change the length of the flow passes 30f-35f provided with pumps 50f-55f and valves 60f-65f as in an embodiment of a microchip 16 of FIG. 7.

The examples of FIGS. 3-6 are not only applicable to the microchip 10 of FIG. 1, but may also be applied to the microchip 11 of FIG. 2.

The present invention is applicable to various examinations, depending on the examination items and number of reagents, by changing the flow pass length and changing the number of flow passes.

An embodiment of a microchip 17 shown in FIG. 8 is an example of a microchip using single flow pass. Reference numbers 20g-25g refer to fluid chambers. In one embodiment, chamber 20g, 22g, and 24g supply washing agent, chamber 21g supplies BPPA substrate, chamber 23g supplies marker antibody, and chamber 25g supplies specimen. Specimen, reagent, and washing agent may be simultaneously injected by five pipettes, or may be supplied by an attached cartridge. The transported fluid may be pushed from each hole of the fluid chambers 20g-25g by a syringe, or may be suctioned from suction port 27, or a micro pump disposed at a suitable position in the portions 30g-37g of the flow pass may be used.

If the microchips 10-17, 70, and 71 described above are used, a very small amount of blood is collected from the patient, on the order of one milliliter or less, thereby reducing the burden on the patient. Furthermore, the examination time can be reduced by performing a consecutive sequence (separation, reaction, washing, and detection) in a very small space.

Since the amount of reagent and waste material is small, the cost of examination can be reduced. Since the examination device is compact, the cost of the device itself becomes inexpensive.

Since the compact device consumes little energy, it is possible to perform examinations anytime, anywhere using battery power.

The present invention is not limited to the above embodiments, and may be embodied in various other modes.

For example, a microchip may be widely used for examinations using antigen-antibody reactions and enzyme reactions in immunological examinations and biochemical examinations. The detection method is not limited to detecting fluorescence generated by excited light, since, for example, the turbidity of the fluid also may be detected.

Furthermore, more precise timing can be attained by controlling the dimensions of the flow pass, the shape of the flow pass cross section, and suitable flow pass resistance.

Although the present invention has been fully described by way of examples and with reference to the accompanying drawings, it is to be understood that various changes and modifications will be apparent to those skilled in the art without departing from the spirit and scope of the invention. Therefore, unless such changes and modifications depart from the scope of the present invention, they should be construed as being included therein.

What is claimed is:

1. A microchip comprising;
a plurality of supply units capable of supplying a plurality of fluids;
a reaction chamber for receiving said plurality of fluids for reaction therein; and
a flow pass, connected between said plurality of supply units and said reaction chamber, for said plurality of fluids to flow to said reaction chamber;
wherein a configuration of said flow pass determines a sequential relationship for each of said plurality of fluids supplied from each of said plurality of supply units to reach said reaction chamber.

2. A microchip according to claim 1, wherein said configuration is selected from the group consisting of:
a dimension of a cross section of said flow pass;
a shape of a cross section of said flow pass;
a length of said flow pass; and
a relative position of each of said plurality of supply units with respect to said flow pass.

3. A microchip according to claim 1, further comprising a suction port, disposed proximate said reaction chamber, for said plurality of fluids to be discharged from said microchip after reaction.

4. A microchip according to claim 1, further comprising a suction unit for suctioning each of said plurality of fluids supplied from each of said plurality of supply units towards said reaction chamber.

5. A microchip according to claim 4, wherein said suction unit is adapted to simultaneously suction said each of said plurality of fluids towards said reaction chamber.

6. A microchip according to claim 4, wherein said suction unit is a micro pump.

7. A microchip according to claim 1, wherein said flow pass comprises a plurality of branch flow passes respectively connected to said plurality of supply units,
wherein a configuration of each of said plurality of branch flow passes determines a sequential relationship for each of said plurality of fluids supplied from each of said plurality of supply units to reach said reaction chamber.

8. A microchip according to claim 7, wherein said configuration of said plurality of branch flow passes is selected from the group consisting of:
a dimension of a cross section of said branch flow pass;
a shape of a cross section of said branch flow pass; and
a length of said branch flow pass.

9. A microchip according to claim 7, further comprising a micro pump disposed in one of said plurality of branch flow passes.

10. A microchip according to claim 7, further comprising a plurality of micro pumps, respective disposed in each of said plurality of branch flow passes.

11. A microchip according to claim 7, further comprising a valve disposed in one of said plurality of branch flow passes.

12. A microchip according to claim 7, further comprising a plurality of micro valves, respectively disposed between each of said plurality of branch flow passes and said reaction chamber.

13. A microchip comprising;
a common flow pass;
a plurality of supply units, sequentially provided on said common flow pass and capable of supplying a plurality of fluids; and
a reaction chamber for receiving said plurality of fluids for reaction therein;
wherein an arrangement order of said plurality of supply units on said common flow pass determines a sequential order for each of said plurality of fluids supplied from each of said plurality of supply units to reach said reaction chamber.

14. A microchip according to claim 13, further comprising a flow controller disposed between one of said plurality of supply units and said common flow pass.

15. A microchip according to claim 14, wherein said flow controller comprises a micro valve.

16. A microchip according to claim 14, wherein said flow controller comprises a micro pump.

17. A microchip comprising;
a plurality of supply units, capable of supplying a plurality of fluids;
a reaction chamber for receiving said plurality of fluids for reaction therein;
a plurality of flow passes respectively connecting each of said plurality of supply units to said reaction chamber;
wherein a configuration of each of said plurality of flow passes determines a sequential order for each of said plurality of fluids supplied from each of said plurality of supply units to reach said reaction chamber.

18. A microchip according to claim 17, further comprising a flow controller for controlling a flow of at least one of said plurality of fluids to said reaction chamber.

19. A microchip according to claim 17, wherein said flow controller comprises a micro valve.

20. A microchip according to claim 17, wherein said flow controller comprises a micro pump.

21. A microchip according to claim 17, wherein said flow controller is disposed in one of said plurality of flow passes.

22. A microchip, comprising:
a plurality of supply units capable of supplying a plurality of fluids for reaction;
a reaction chamber for containing said reaction;
a plurality of flow passes respectively connecting said plurality of supply units to said reaction chamber;
wherein said plurality of fluids reach said reaction chamber in a sequence based on the respective dimensions of each of said plurality of flow passes.

23. A microchip according to claim 22, wherein said sequence in which each of said plurality of fluids reach said reaction chamber is based on the relative distances between each of said plurality of supply units and said reaction chamber.

24. A microchip according to claim 22, wherein said sequence in which each of said plurality of fluids reach said reaction chamber is based on the relative lengths of each of said plurality of flow passes connecting each of said plurality of supply units to said reaction chamber.

25. A microchip according to claim 22, further comprising a flow controller disposed between one of said plurality of supply units and said common flow pass.

26. A microchip according to claim 25, wherein said flow controller comprises a micro valve.

27. A microchip according to claim 25, wherein said flow controller comprises a micro pump.

28. A microchip, comprising:
a plurality of supply units capable of supplying a plurality of fluids for reaction;
a reaction chamber for containing said reaction;
a common flow pass connected to said reaction chamber;
a plurality of branch flow passes respectively connecting said plurality of supply units to said common flow pass;
wherein said plurality of fluids reach said reaction chamber in a sequence based on the respective dimensions of each of said plurality of branch flow passes.

29. A microchip according to claim 28, wherein said sequence in which each of said plurality of fluids reach said reaction chamber is based on the relative distances between each of said plurality of supply units and said reaction chamber.

30. A microchip according to claim 28, wherein said sequence in which each of said plurality of fluids reach said reaction chamber is based on the relative lengths of each of said plurality of branch flow passes connecting each of said plurality of supply units to said common flow pass.

31. A microchip according to claim 28, further comprising a flow controller disposed between one of said plurality of supply units and said common flow pass.

32. A microchip according to claim 31, wherein said flow controller comprises a micro valve.

33. A microchip according to claim 31, wherein said flow controller comprises a micro pump.

34. A method for performing a reaction in a microchip, comprising the steps of:
causing a first fluid to flow from a first supply unit, via a first branch flow pass, into a reaction chamber;
causing a second fluid to flow from a second supply unit, via a second branch flow pass, into said reaction chamber;
causing a third fluid to flow from a third supply unit, via a third branch flow pass, into said reaction chamber;
wherein said first, second and third fluids reach said reaction chamber in a sequence based on the relative dimensions of each of said first, second, and third branch flow passes.

35. A method according to claim 34, wherein a common flow pass connects said first, second, and third branch flow passes to said reaction chamber.

36. A method according to claim 34, wherein said first, second, and third branch flow passes are directly connected to said reaction chamber.

37. A method according to claim 34, further comprising the step of controlling a flow of fluid from one of said first, second, and third branch flow passes using a flow controller disposed between a respective one of said first, second, and third supply units and said reaction chamber.

38. A method according to claim 37, wherein said flow controller comprises a micro valve.

39. A method according to claim 37, wherein said flow controller comprises a micro pump.
